(19) United States
(12) Patent Application Publication
(10) Pub. No.: US 2020/0307638 A1
(43) Pub. Date: Oct. 1, 2020

(54) VEHICLE CONTROL SYSTEM

(71) Applicant: HONDA MOTOR CO., LTD., Tokyo (JP)

(72) Inventor: Kanta TSUJI, Wako-shi (JP)

(21) Appl. No.: 16/831,234

(22) Filed: Mar. 26, 2020

(30) Foreign Application Priority Data
Mar. 29, 2019 (JP) 2019067801

(51) Int. Cl. B60W 60/00; B60Q 1/06; B60W 10/30; B60W 10/20; B60W 40/09

(52) U.S. Cl. CPC B60W 60/0051; B60W 60/0018; B60Q 1/06; B62D 1/06; B60W 10/20; B60W 40/09; B60W 10/30

(57) ABSTRACT

In a vehicle control system (1, 101, 201) configured for autonomous driving, and having a control unit configured to execute a stop process by which the vehicle is parked in a prescribed stop area when it is detected that the control unit or a driver has become incapable of properly maintaining a traveling state of the vehicle comprising, an external notification unit (14) includes a headlight, and the control unit is configured to change a lighting mode of the headlight in a repetitive manner in the stop process.

### TECHNICAL FIELD

The present invention relates to a vehicle control system configured for autonomous driving.

### BACKGROUND ART

According to a known travel control system that autonomously drives the vehicle to a suitable stop position and park the vehicle at the stop position when the driver is detected to be unable to continue to properly drive the vehicle. See JP2016-196285A, for example. According to this prior art, when the vehicle is being autonomously driven to the stop position, the headlight is turned on so as to warn the surrounding vehicles of the occurrence of an emergency situation.

The headlight is used whenever the vehicle is traveling at night or in a dark condition. Therefore, simply turning on the headlight may not properly warn the surrounding vehicles and pedestrians of the occurrence of an emergency situation.

### SUMMARY OF THE INVENTION

In view of such a problem of the prior art, a primary object of the present invention is to provide a vehicle control system configured for autonomous driving which can warn the surrounding vehicles and pedestrians in a reliable manner when the driver of the vehicle has become unable to properly drive the vehicle.

To achieve such an object, the present invention provides a vehicle control system (1, 101, 201) configured for autonomous driving, comprising:
a control unit (15) for steering, accelerating, and decelerating a vehicle; and
an external notification device (14) using light;
wherein the control unit is configured to execute a stop process by which the vehicle is parked in a prescribed stop area when it is detected that the control unit or a driver has become incapable of properly maintaining a traveling state of the vehicle, and
wherein the external notification device includes a headlight, and the control unit is configured to change a lighting mode of the headlight in a repetitive manner in the stop process.

When the driver is detected to be in an abnormal state which prevents the driver to take over the driving, the stop process may be initiated so that that the vehicle may be autonomously driven to a stop position to be parked thereat. At such a time, the lighting mode of the headlight is repeatedly changed. In particular, the headlight is caused to operate in a manner different from simple lighting to allow pedestrians and occupants of surrounding vehicles to recognize an occurrence of an emergency situation.

Preferably, the headlight is configured to be selectable to be in a first state and a second state demonstrating two different irradiation ranges, and the control unit is configured to cause the first state and the second state to alternate in a repetitive manner.

Thereby, pedestrians and occupants of other vehicles can readily recognize the occurrence of an emergency situation.

Preferably, the headlight includes a first light source and a second light source having to different irradiation ranges, the first light source being turned on while the second light source is turned off in the first state, the first light source being turned off while the second light source is turned on in the second state.

Thereby, the lighting mode of the headlight can be changed in a highly conspicuous manner simply by turning on the first light sources and the second light sources in an alternating manner.

Preferably, the headlight includes a first light source and a second light source having different irradiation ranges, the first light source being turned on while the second light source is turned off in the first state, the first light source and the second light source being both turned on in the second state.

Since the first light sources are not required to be turned off during the process of changing the lighting mode of the headlight, the first light sources may be selected from those requiring a certain time period before becoming fully bright after being turned on.

Preferably, the headlight includes a light source which is selectable to have a first irradiation direction directed lower than a horizontal direction, and a second irradiation direction higher than the first direction, the first state and the second state corresponding to the first irradiation direction and the second irradiation direction, respectively.

Thus, the light source is not required to be turned on and off between the first state and the second state so that the light source can be selected from those requiring a certain time period before becoming fully bright after being turned on. Also, the light source may consist of a single light source as opposed to the arrangement where different light sources are switched from one to the other so that the number of light sources can be minimized.

Preferably, the vehicle control system further comprises an occupant monitoring device, and the control unit is configured to prohibit the lighting mode of the headlight from being changed in the repetitive manner in the stop process when the occupant monitoring device indicates that the driver is in a good health.

When the driver is in a normal health condition, and may have failed to respond to a request to take over the driving for other causes, the driver should be able to cope with the situation on one's own. It is therefore advantageous to restrict the switching of the lighting mode. As a result, when there is no problem in the health condition of the driver and no urgency is required, it is possible to prevent unnecessarily alarming the surrounding pedestrians and the occupants of the surrounding vehicles.

Preferably, the external notification device further includes a taillight (14g), wherein the control unit turns on the taillight as well as the headlight in the stop process.

Thereby, the urgent situation in which the driver is unable to take over the driving can be easily recognized by the occupant of the following vehicle.

The present invention thus provides a vehicle control system configured for autonomous driving which can warn the surrounding vehicles and pedestrians in a reliable manner when the driver of the vehicle has become unable to properly drive the vehicle.

### BRIEF DESCRIPTION OF THE DRAWING(S)

FIG. 1 is a functional block diagram of a vehicle on which a vehicle control system according to the present invention is mounted;

FIG. 2 is a flowchart of a stop process;

FIG. 3 is a functional block diagram of an external notification device;

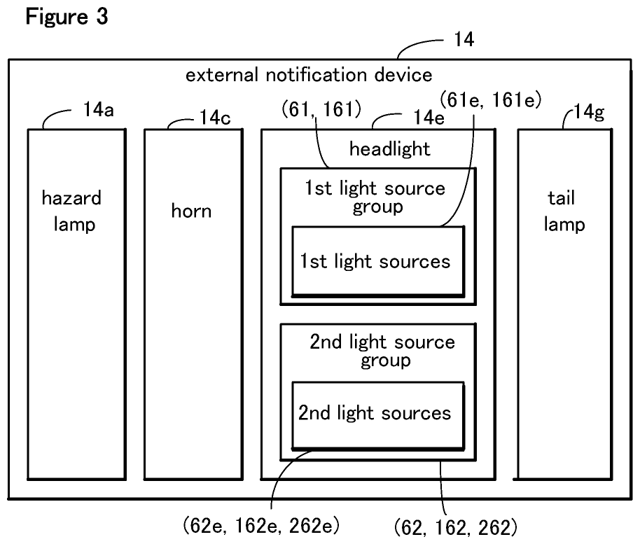

FIG. 4 is a flow chart of a notification process according to a first embodiment of the present invention; and

FIG. 5 is a flow chart of a stop maintaining process according to a fourth embodiment of the present invention.

### DESCRIPTION OF THE PREFERRED EMBODIMENT(S)

A vehicle control system according to a preferred embodiment of the present invention is described in the following with reference to the appended drawings. The following disclosure is according to left-hand traffic. In the case of right-hand traffic, the left and the right in the disclosure will be reversed.

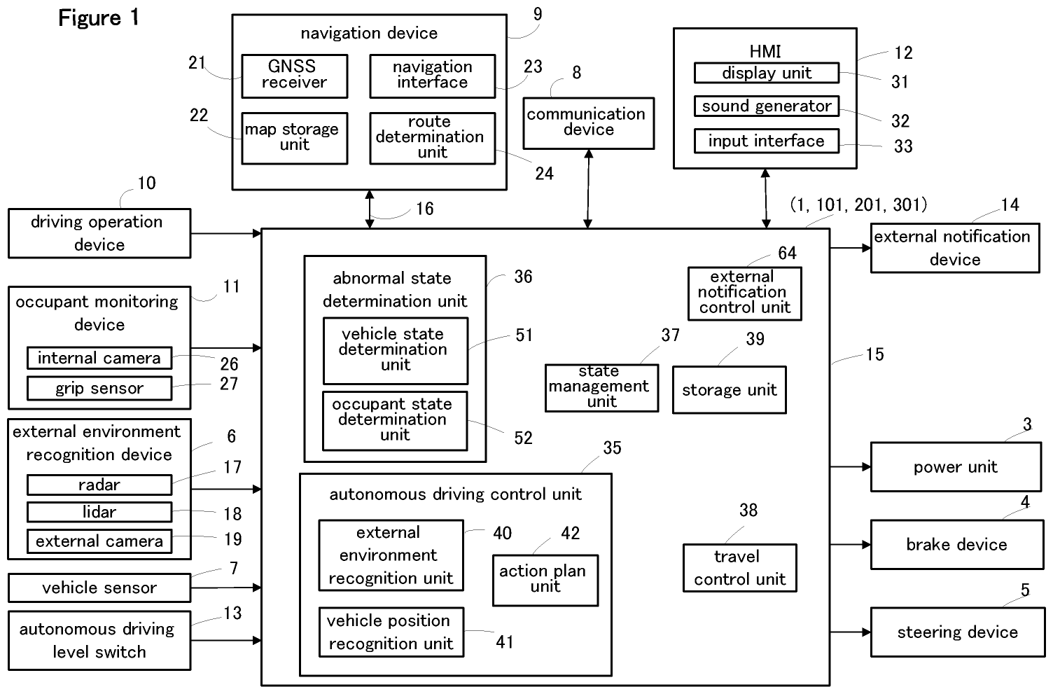

As shown in FIG. 1, the vehicle control system 1 according to the present invention is a part of a vehicle system 2 mounted on a vehicle. The vehicle system 2 includes a power unit 3, a brake device 4, a steering device 5, an external environment recognition device 6, a vehicle sensor 7, a communication device 8, a navigation device 9 (map device), a driving operation device 10, an occupant monitoring device 11, an HMI 12 (Human Machine Interface), an autonomous driving level switch 13, an external notification device 14, and a control unit 15. These components of the vehicle system 2 are connected to one another so that signals can be transmitted between them via a communication means such as CAN 16 (Controller Area Network).

The power unit 3 is a device for applying a driving force to the vehicle, and may include a power source and a transmission unit. The power source may consist of an internal combustion engine such as a gasoline engine and a diesel engine, an electric motor or a combination of these. The brake device 4 is a device that applies a brake force to the vehicle, and may include a brake caliper that presses a brake pad against a brake rotor, and an electrically actuated hydraulic cylinder that supplies hydraulic pressure to the brake caliper. The brake device 4 may also include a parking brake device. The steering device 5 is a device for changing a steering angle of the wheels, and may include a rack-and-pinion mechanism that steers the front wheels, and an electric motor that drives the rack-and-pinion mechanism. The power unit 3, the brake device 4, and the steering device 5 are controlled by the control unit 15.

The external environment recognition device 6 is a device that detects objects located outside of the vehicle. The external environment recognition device 6 may include a sensor that captures electromagnetic waves or light from around the vehicle to detect objects outside of the vehicle, and may consist of a radar 17, a lidar 18, an external camera 19, or a combination of these. The external environment recognition device 6 may also be configured to detect objects outside of the vehicle by receiving a signal from a source outside of the vehicle. The detection result of the external environment recognition device 6 is forwarded to the control unit 15.

The radar 17 emits radio waves such as millimeter waves to the surrounding area of the vehicle, and detects the position (distance and direction) of an object by capturing the reflected wave. Preferably, the radar 17 includes a front radar that radiates radio waves toward the front of the vehicle, a rear radar that radiates radio waves toward the rear of the vehicle, and a pair of side radars that radiates radio waves in the lateral directions.

The lidar 18 emits light such as an infrared ray to the surrounding part of the vehicle, and detects the position (distance and direction) of an object by capturing the reflected light. At least one lidar 18 is provided at a suitable position of the vehicle.

The external camera 19 can capture the image of the surrounding objects such as vehicles, pedestrians, guardrails, curbs, walls, median strips, road shapes, road signs, road markings painted on the road, and the like. The external camera 19 may consist of a digital camera using a solid-state imaging device such as a CCD and a CMOS. At least one external camera 19 is provided at a suitable position of the vehicle. The external camera 19 preferably includes a front camera that images the front of the vehicle, a rear camera that images the rear of the vehicle and a pair of side cameras that image the lateral views from the vehicle. The external camera 19 may consist of a stereo camera that can capture a three-dimensional image of the surrounding objects.

The vehicle sensor 7 may include a vehicle speed sensor that detects the traveling speed of the vehicle, an acceleration sensor that detects the acceleration of the vehicle, a yaw rate sensor that detects an angular velocity of the vehicle around a vertical axis, a direction sensor that detects the traveling direction of the vehicle, and the like. The yaw rate sensor may consist of a gyro sensor.

The communication device 8 allows communication between the control unit 15 which is connected to the navigation device 9 and other vehicles around the own vehicle as well as servers located outside the vehicle. The control unit 15 can perform wireless communication with the surrounding vehicles via the communication device 8. For instance, the control unit 15 can communicate with a server that provides traffic regulation information via the communication device 8, and with an emergency call center that accepts an emergency call from the vehicle also via the communication device 8. Further, the control unit 15 can communicate with a portable terminal carried by a person such as a pedestrian present outside the vehicle via the communication device 8.

The navigation device 9 is able to identify the current position of the vehicle, and performs route guidance to a destination and the like, and may include a GNSS receiver 21, a map storage unit 22, a navigation interface 23, and a route determination unit 24. The GNSS receiver 21 identifies the position (latitude and longitude) of the vehicle according to a signal received from artificial satellites (positioning satellites). The map storage unit 22 may consist of a per se known storage device such as a flash memory and a hard disk, and stores or retains map information. The navigation interface 23 receives an input of a destination or the like from the user, and provides various information to the user by visual display and/or speech. The navigation interface 23 may include a touch panel display, a speaker, and the like. In another embodiment, the GNSS receiver 21 is configured as a part of the communication device 8. The map storage unit 22 may be configured as a part of the control unit 15 or may be configured as a part of an external server that can communicate with the control unit 15 via the communication device 8.

The map information may include a wide range of road information which may include, not exclusively, road types such as expressways, toll roads, national roads, and prefectural roads, the number of lanes of the road, road markings such as the center position of each lane (three-dimensional coordinates including longitude, latitude, and height), road division lines and lane lines, the presence or absence of sidewalks, curbs, fences, etc., the locations of intersections, the locations of merging and branching points of lanes, the areas of emergency parking zones, the width of each lane, and traffic signs provided along the roads. The map information may also include traffic regulation information, address information (address/postal code), facility information, telephone number information, and the like.

The route determination unit 24 determines a route to the destination according to the position of the vehicle specified by the GNSS receiver 21, the destination input from the navigation interface 23, and the map information. When determining the route, in addition to the route, the route determination unit 24 determines the target lane which the vehicle will travel in by referring to the merging and branching points of the lanes in the map information.

The driving operation device 10 receives an input operation performed by the driver to control the vehicle. The driving operation device 10 may include a steering wheel, an accelerator pedal, and a brake pedal. Further, the driving operation device 10 may include a shift lever, a parking brake lever, and the like. Each element of the driving operation device 10 is provided with a sensor for detecting an operation amount of the corresponding operation. The driving operation device 10 outputs a signal indicating the operation amount to the control unit 15.

The occupant monitoring device 11 monitors the state of the occupant in the passenger compartment. The occupant monitoring device 11 includes, for example, an internal camera 26 that images an occupant sitting on a seat in the vehicle cabin, and a grip sensor 27 provided on the steering wheel. The internal camera 26 is a digital camera using a solid-state imaging device such as a CCD and a CMOS. The grip sensor 27 is a sensor that detects if the driver is gripping the steering wheel, and outputs the presence or absence of the grip as a detection signal. The grip sensor 27 may be formed of a capacitance sensor or a piezoelectric device provided on the steering wheel. The occupant monitoring device 11 may include a heart rate sensor provided on the steering wheel or the seat, or a seating sensor provided on the seat. In addition, the occupant monitoring device 11 may be a wearable device that is worn by the occupant, and can detect the vital information of the driver including at least one of the heart rate and the blood pressure of the driver. In this conjunction, the occupant monitoring device 11 may be configured to be able to communicate with the control unit 15 via a per se known wireless communication means. The occupant monitoring device 11 outputs the captured image and the detection signal to the control unit 15.

The external notification device 14 is a device for notifying to people outside of the vehicle by sound and/or light, and may include a warning light and a horn. A headlight (front light), a taillight, a brake lamp, a hazard lamp, and a vehicle interior light may function as a warning light.

The HMI 12 notifies the occupant of various kinds of information by visual display and speech, and receives an input operation by the occupant. The HMI 12 may include at least one of a display device 31 such as a touch panel and an indicator light including an LCD or an organic EL, a sound generator 32 such as a buzzer and a speaker, and an input interface 33 such as a GUI switch on the touch panel and a mechanical switch. The navigation interface 23 may be configured to function as the HMI 12.

The autonomous driving level switch 13 is a switch that activates autonomous driving as a command from the driver. The autonomous driving level switch 13 may be a mechanical switch or a GUI switch displayed on the touch panel, and is positioned in a suitable part of the cabin. The autonomous driving level switch 13 may be formed by the input interface 33 of the HMI 12 or may be formed by the navigation interface 23.

The control unit 15 may consist of an electronic control unit (ECU) including a CPU, a ROM, a RAM, and the like. The control unit 15 executes various types of vehicle control by executing arithmetic processes according to a computer program executed by the CPU. The control unit 15 may be configured as a single piece of hardware, or may be configured as a unit including a plurality of pieces of hardware. In addition, at least a part of each functional unit of the control unit 15 may be realized by hardware such as an LSI, an ASIC, and an FPGA, or may be realized by a combination of software and hardware.

The control unit 15 is configured to execute autonomous driving control of at least level 0 to level 3 by combining various types of vehicle control. The level is according to the definition of SAE J3016, and is determined in relation to the degree of machine intervention in the driving operation of the driver and in the monitoring of the surrounding environment of the vehicle.

In autonomous driving of level 0, the control unit 15 does not control the vehicle, and the driver performs all of the driving operations. Thus, autonomous driving of level 0 means a manual driving.

In autonomous driving of level 1, the control unit 15 executes a certain part of the driving operation, and the driver performs the remaining part of the driving operation. For example, autonomous driving level 1 includes constant speed traveling, inter-vehicle distance control (ACC; Adaptive Cruise Control) and lane keeping assist control (LKAS; Lane Keeping Assistance System). The level 1 autonomous driving is executed when various devices (for example, the external environment recognition device 6 and the vehicle sensor 7) required for executing the level 1 autonomous driving are all properly functioning. In autonomous driving of level 2, the control unit 15 performs the entire driving operation. The level 2 autonomous driving is performed only when the driver monitors the surrounding environment of the vehicle, the vehicle is within a designated area, and the various devices required for performing the level 2 autonomous driving are all functioning properly.

In level 3 autonomous driving, the control unit 15 performs the entire driving operation. The level 3 autonomous driving requires the driver to monitor or be aware of the surrounding environment when required, and is executed only when the vehicle is within a designated area, and the various devices required for performing the level 3 autonomous driving are all functioning properly. The conditions under which the level 3 autonomous driving is executed may include that the vehicle is traveling on a congested road. Whether the vehicle is traveling on a congested road or not may be determined according to traffic regulation information provided from a server outside of the vehicle, or, alternatively, that the vehicle speed detected by the vehicle speed sensor is determined to be lower than a predetermined slowdown determination value (for example, 30 km/h) over a predetermined time period.

Thus, in the autonomous driving of levels 1 to 3, the control unit 15 executes at least one of the steering, the acceleration, the deceleration, and the monitoring of the surrounding environment. When in the autonomous driving mode, the control unit 15 executes the autonomous driving of level 1 to level 3. Hereinafter, the steering, acceleration, and deceleration operations are collectively referred to as driving operation, and the driving and the monitoring of the surrounding environment may be collectively referred to as driving.

In the present embodiment, when the control unit 15 has received a command to execute autonomous driving via the autonomous driving level switch 13, the control unit 15 selects the autonomous driving level that is suitable for the environment of the vehicle according to the detection result of the external environment recognition device 6 and the position of the vehicle acquired by the navigation device 9, and changes the autonomous driving level as required. However, the control unit 15 may also change the autonomous driving level according the input to the autonomous driving level switch 13.

As shown in FIG. 1, the control unit 15 includes an autonomous driving control unit 35, an abnormal state determination unit 36, a state management unit 37, a travel control unit 38, and a storage unit 39.

The autonomous driving control unit 35 includes an external environment recognition unit 40, a vehicle position recognition unit 41, and an action plan unit 42. The external environment recognition unit 40 recognizes an obstacle located around the vehicle, the shape of the road, the presence or absence of a sidewalk, and road signs according to the detection result of the external environment recognition device 6. The obstacles include, not exclusively, guardrails, telephone poles, surrounding vehicles, and pedestrians. The external environment recognition unit 40 can acquire the state of the surrounding vehicles, such as the position, speed, and acceleration of each surrounding vehicle from the detection result of the external environment recognition device 6. The position of each surrounding vehicle may be recognized as a representative point such as a center of gravity position or a corner positions of the surrounding vehicle, or an area represented by the contour of the surrounding vehicle.

The vehicle position recognition unit 41 recognizes a traveling lane, which is a lane in which the vehicle is traveling, and a relative position and an angle of the vehicle with respect to the traveling lane. The vehicle position recognition unit 41 may recognize the traveling lane according to the map information stored in the map storage unit 22 and the position of the vehicle acquired by the GNSS receiver 21. In addition, the lane markings drawn on the road surface around the vehicle may be extracted from the map information, and the relative position and angle of the vehicle with respect to the traveling lane may be recognized by comparing the extracted lane markings with the lane markings captured by the external camera 19.

The action plan unit 42 sequentially creates an action plan for driving the vehicle along the route. More specifically, the action plan unit 42 first determines a set of events for traveling on the target lane determined by the route determination unit 24 without the vehicle coming into contact with an obstacle. The events may include a constant speed traveling event in which the vehicle travels in the same lane at a constant speed, a preceding vehicle following event in which the vehicle follows a preceding vehicle at a certain speed which is equal to or lower than a speed selected by the driver or a speed which is determined by the prevailing environment, a lane changing event in which the vehicle change lanes, a passing event in which the vehicle passes a preceding vehicle, a merging event in which the vehicle merge into the traffic from another road at a junction of the road, a diverging event in which the vehicle travels into a selected road at a junction of the road, an autonomous driving end event in which autonomous driving is ended, and the driver takes over the driving operation, and a stop event in which the vehicle is brought to a stop when a certain condition is met, the condition including a case where the control unit 15 or the driver has become incapable of continuing the driving operation.

The conditions under which the action plan unit 42 invokes the stop event include the case where an input to the internal camera 26, the grip sensor 27, or the autonomous driving level switch 13 in response to an intervention request (a hand-over request) to the driver is not detected during autonomous driving. The intervention request is a warning to the driver to take over a part of the driving, and to perform at least one of the driving operation and the monitoring of the environment corresponding to the part of the driving that is to be handed over. The condition under which the action plan unit 42 invokes the stop even include the case where the action plan unit 42 has detected that the driver has become incapable of performing the driving while the vehicle is traveling due to a physiological ailment according to the signal from a pulse sensor, the internal camera or the like.

During the execution of these events, the action plan unit 42 may invoke an avoidance event for avoiding an obstacle or the like according to the surrounding conditions of the vehicle (existence of nearby vehicles and pedestrians, lane narrowing due to road construction, etc.).

The action plan unit 42 generates a target trajectory for the vehicle to travel in the future corresponding to the selected event. The target trajectory is obtained by sequentially arranging trajectory points that the vehicle should trace at each time point. The action plan unit 42 may generate the target trajectory according to the target speed and the target acceleration set for each event. At this time, the information on the target speed and the target acceleration is determined for each interval between the trajectory points.

The travel control unit 38 controls the power unit 3, the brake device 4, and the steering device 5 so that the vehicle traces the target trajectory generated by the action plan unit 42 according to the schedule also generated by the action plan unit 42.

The storage unit 39 is formed by a ROM, a RAM, or the like, and stores information required for the processing by the autonomous driving control unit 35, the abnormal state determination unit 36, the state management unit 37, and the travel control unit 38.

The abnormal state determination unit 36 includes a vehicle state determination unit 51 and an occupant state determination unit 52. The vehicle state determination unit 51 analyzes signals from various devices (for example, the external environment recognition device 6 and the vehicle sensor 7) that affect the level of the autonomous driving that is being executed, and detects the occurrence of an abnormality in any of the devices and units that may prevent a proper execution of the autonomous driving of the level that is being executed.

The occupant state determination unit 52 determines if the driver is in an abnormal state or not according to a signal from the occupant monitoring device 11. The abnormal state includes the case where the driver is unable to properly steer the vehicle in autonomous driving of level 1 or lower that requires the driver to steer the vehicle.

That the driver is unable to steer the vehicle in autonomous driving of level 1 or lower could mean that the driver is not holding the steering wheel, the driver is asleep, the driver is incapacitated or unconscious due to illness or injury, or the driver is under a cardiac arrest. The occupant state determination unit 52 determines that the driver is in an abnormal state when there is no input to the grip sensor 27 from the driver while in autonomous driving of level 1 or lower that requires the driver to steer the vehicle. Further, the occupant state determination unit 52 may determine the open/closed state of the driver's eyelids from the face image of the driver that is extracted from the output of the internal camera 26. The occupant state determination unit 52 may determine that the driver is asleep, under a strong drowsiness, unconscious or under a cardiac arrest so that the drive is unable to properly drive the vehicle, and the driver is in an abnormal condition when the driver's eyelids are closed for more than a predetermined time period, or when the number of times the eyelids are closed per unit time interval is equal to or greater than a predetermined threshold value. The occupant state determination unit 52 may further acquire the driver's posture from the captured image to determine that the driver's posture is not suitable for the driving operation or that the posture of the driver does not change for a predetermined time period. It may well mean that the driver is incapacitated due to illness or injury, and in an abnormal condition.

In the case of autonomous driving of level 2 or lower, the abnormal condition includes a situation where the driver is neglecting the duty to monitor the environment surrounding the vehicle. This situation may include either the case where the driver is not holding or gripping the steering wheel or the case where the driver's line of sight is not directed in the forward direction. The occupant state determination unit 52 may detect the abnormal condition where the driver is neglecting to monitor the environment surrounding the vehicle when the output signal of the grip sensor 27 indicates that the driver is not holding the steering wheel. The occupant state determination unit 52 may detect the abnormal condition according to the image captured by the internal camera 26. The occupant state determination unit 52 may use a per se known image analysis technique to extract the face region of the driver from the captured image, and then extracts the iris parts (hereinafter, iris) including the inner and outer corners of the eyes and pupils from the extracted face area. The occupant state determination unit 52 may detect the driver's line of sight according to the positions of the inner and outer corners of the eyes, the iris, the outline of the iris, and the like. It is determined that the driver is neglecting the duty to monitor the environment surrounding the vehicle when the driver's line of sight is not directed in the forward direction.

In addition, in the autonomous driving at a level where the drive is not required to monitor the surrounding environment or in the autonomous driving of level 3, an abnormal condition refers to a state in which the driver cannot promptly take over the driving when a driving takeover request is issued to the driver. The state where the driver cannot take over the driving includes the state where the system cannot be monitored, or, in other words, where the driver cannot monitor a screen display that may be showing an alarm display such as when the driver is asleep, and when the driver is not looking ahead. In the present embodiment, in the level 3 autonomous driving, the abnormal condition includes a case where the driver cannot perform the duty of monitoring the surrounding environment of the vehicle even though the driver is notified to monitor the surrounding environment of the vehicle. In the present embodiment, the occupant state determination unit 52 displays a predetermined screen on the display device 31 of the HMI 12, and commands the driver to look at the display device 31. Thereafter, the occupant state determination unit 52 detects the driver's line of sight with the internal camera 26, and determines that the driver is unable to fulfill the duty of monitoring the surrounding environment of the vehicle if driver's line of sight is not facing the display device 31 of the HMI 12.

The occupant state determination unit 52 may detect if the driver is gripping the steering wheel according to the signal from the grip sensor 27, and if the driver is not gripping the steering wheel, it can be determined that the vehicle is in an abnormal state in which the duty of monitoring the surrounding environment the vehicle is being neglected. Further, the occupant state determination unit 52 determines if the driver is in an abnormal state according to the image captured by the internal camera 26. For example, the occupant state determination unit 52 extracts a driver's face region from the captured image by using a per se known image analysis means. The occupant state determination unit 52 may further extract iris parts (hereinafter, iris) of the driver including the inner and outer corners of the eyes and pupils from the extracted face area. The occupant state determination unit 52 obtains the driver's line of sight according to the extracted positions of the inner and outer corners of the eyes, the iris, the outline of the iris, and the like. It is determined that the driver is neglecting the duty to monitor the environment surrounding the vehicle when the driver's line of sight is not directed in the forward direction.

The state management unit 37 selects the level of the autonomous driving according to at least one of the own vehicle position, the operation of the autonomous driving level switch 13, and the determination result of the abnormal state determination unit 36. Further, the state management unit 37 controls the action plan unit 42 according to the selected autonomous driving level, thereby performing the autonomous driving according to the selected autonomous driving level. For example, when the state management unit 37 has selected the level 1 autonomous driving, and a constant speed traveling control is being executed, the event to be determined by the action plan unit 42 is limited only to the constant speed traveling event.

The state management unit 37 raises and lowers the autonomous driving level as required in addition to executing the autonomous driving according to the selected level.

More specifically, the state management unit 37 raises the level when the condition for executing the autonomous driving at the selected level is met and a command to raise the level of the autonomous driving is input to the autonomous driving level switch 13.

When the condition for executing the autonomous driving of the current level ceases to be satisfied, or when a command to lower the level of the autonomous driving is input to the autonomous driving level switch 13, the state management unit 37 executes an intervention request process. In the intervention request process, the state management unit 37 first notifies the driver of a handover request. The notification to the driver may be made by displaying a message or image on the display device 31 or generating a speech or an acoustic notification from the sound generator 32. The notification to the driver may continue for a predetermined period of time after the intervention request process is started or may be continued until an input is detected by the occupant monitoring device 11.

The condition for executing the autonomous driving of the current level ceases to be satisfied when the vehicle has moved to an area where only the autonomous driving of a level lower than the current level is permitted, or when the abnormal state determination unit 36 has determined that an abnormal condition that prevents the continuation of the autonomous driving of the current level has occurred to the driver or the vehicle.

Following the notification to the driver, the state management unit 37 detects if the internal camera 26 or the grip sensor 27 has received an input from the driver indicating a takeover of the driving. The detection of the presence or absence of an input to take over the driving is determined in a way that depends on the level that is to be selected. When moving to level 2, the state management unit 37 extracts the driver's line of sight from the image acquired by the internal camera 26, and when the driver's line of sight is facing the front of the vehicle, it is determined that an input indicating the takeover of the driving by the driver is received. When moving to level 1 or level 0, the state management unit 37 determines that there is an input indicating an intent to take over the driving when the grip sensor 27 has detected the gripping of the steering wheel by the driver. Thus, the internal camera 26 and the grip sensor 27 function as an intervention detection device that detects an intervention of the driver to the driving. Further, the state management unit 37 may detect if there is an input indicating an intervention of the driver to the driving according to the input to the autonomous driving level switch 13.

The state management unit 37 lowers the autonomous driving level when an input indicating an intervention to the driving is detected within a predetermined period of time from the start of the intervention request process. At this time, the level of the autonomous driving after the lowering of the level may be level 0, or may be the highest level that can be executed. The state management unit 37 causes the action plan unit 42 to generate a stop event when an input corresponding to the driver's intervention to the driving is not detected within a predetermined period of time after the execution of the intervention request process. The stop event is an event in which the vehicle is brought to a stop at a safe position (for example, an emergency parking zone, a roadside zone, a roadside shoulder, a parking area, etc.) while the vehicle control is degenerated. Here, a series of procedures executed in the stop event may be referred to as MRM (Minimum Risk Maneuver).

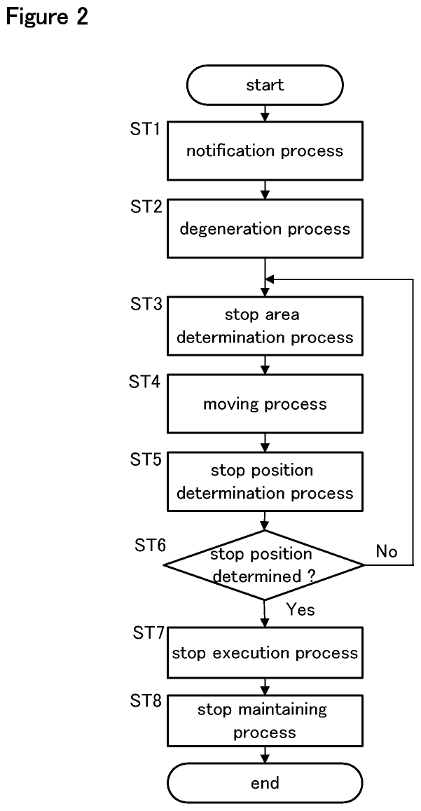

When the stop event is invoked, the control unit 15 shifts from the autonomous driving mode to the autonomous stopping mode, and the action plan unit 42 executes the stop process. Hereinafter, an outline of the stop process is described with reference to the flowchart of FIG. 2.

In the stop process, a notification process is first executed (step ST1). In the notification process, the action plan unit 42 operates the external notification device 14 to notify the people outside of the vehicle. For example, the action plan unit 42 activates a horn included in the external notification device 14 to periodically generate an acoustic notification. The notification process continues until the stop process ends. After the notification process has ended, the action plan unit 42 may continue to activate the horn to generate an acoustic notification depending on the situation.

Then, a degeneration process is executed (step ST2). The degeneration process is a process of restricting events that can be invoked by the action plan unit 42. The degeneration process may prohibit a lane change event to a passing lane, a passing event, a merging event, and the like. Further, in the degeneration process, the speed upper limit and the acceleration upper limit of the vehicle may be more limited in the respective events as compared with the case where the stop process is not performed.

Next, a stop area determination process is executed (step ST3). The stop area determination process refers to the map information according to the current position of the own vehicle, and extracts a plurality of available stop areas (candidates for the stop area or potential stop areas) suitable for stopping, such as road shoulders and evacuation spaces in the traveling direction of the own vehicle. Then, one of the available stop areas is selected as the stop area by taking into account the size of the stop area, the distance to the stop area, and the like.

Next, a moving process is executed (step ST4). In the moving process, a route for reaching the stop area is determined, various events along the route leading to the stop area are generated, and a target trajectory is determined. The travel control unit 38 controls the power unit 3, the brake device 4, and the steering device 5 according to the target trajectory determined by the action plan unit 42. The vehicle then travels along the route and reaches the stop area.

Next, a stop position determination process is executed (step ST5). In the stop position determination process, the stop position is determined according to obstacles, road markings, and other objects located around the vehicle recognized by the external environment recognition unit 40. In the stop position determination process, it is possible that the stop position cannot be determined in the stop area due to the presence of surrounding vehicles and obstacles. When the stop position cannot be determined in the stop position determination process (No in step ST6), the stop area determination process (step ST3), the movement process (step ST4), and the stop position determination process (step ST5) are sequentially repeated.

If the stop position can be determined in the stop position determination process (Yes in step ST6), a stop execution process is executed (step ST7). In the stop execution process, the action plan unit 42 generates a target trajectory according to the current position of the vehicle and the targeted stop position. The travel control unit 38 controls the power unit 3, the brake device 4, and the steering device 5 according to the target trajectory determined by the action plan unit 42. The vehicle then moves toward the stop position and stops at the stop position.

After the stop execution process is executed, a stop maintaining process is executed (step ST8). In the stop maintaining process, the travel control unit 38 drives the parking brake device according to a command from the action plan unit 42 to maintain the vehicle at the stop position. Thereafter, the action plan unit 42 may transmit an emergency call to the emergency call center by the communication device 8. When the stop maintaining process is completed, the stop process ends.

In the present embodiment, the vehicle control system 1 includes the control unit 15, the occupant monitoring device 11 providing the functions of a driver intervention detection device, and the external notification device 14 as mentioned earlier, and the control unit 15 is configured to notify the vehicles and pedestrians which may be present around the own vehicle of an occurrence of an emergency situation such as when the driver has become unable to take over the driving or otherwise has become unable to continue the proper traveling state of the own vehicle by changing the lighting mode of the headlight. To achieve this goal, the external notification device 14 may include a hazard lamp 14a, a horn 14c, a headlight 4e and a taillight 14g, and the control unit 15 includes an external notification control unit 64 for controlling the external notification device 14.

The hazard lamp 14a includes a pair of light sources provided on either side of the front end of the vehicle and a pair of light sources provided on either side of the rear end of the vehicle. The external notification control unit 64 is configured to control the voltage applied to each light source of the hazard lamp 14a provided on the front and rear ends of the vehicle according to a signal from the action plan unit 42, and the mode of turning on and off of each light source.

The horn 14c is one of possible acoustic warning devices that can be used to warn the surroundings of danger by sound. The external notification control unit 64 can control the voltage applied to the horn 14c according to the signal from the action plan unit 42, and the sounding mode of the horn 14c.

The headlight 14e includes a first light source group 61 and a second light source group 62. The first light source group 61 includes at least one pair of first light sources 61e provided on either side of the front end of the vehicle. The irradiation distance of the first light sources 61e (the irradiation distance at the time of lighting) is equal to each other. The second light source group 62 includes at least a pair of second light sources 62e provided on either side of the front end of the vehicle. The irradiation distances of the second light sources 62e are also equal to each other. The irradiation distance of the first light sources 61e is shorter than the irradiation distance of the second light sources 62e. In the present embodiment, the irradiation distance of the first light sources 61e is set to 40 m, and the irradiation distance of the second light sources 62e is set to 100 m. Further, the first light sources 61e and the second light sources 62e are preferably LED lamps or halogen lamps.

The external notification control unit 64 controls the turning on and off of the first light source group 61 and the second light source group 62 by controlling the voltage applied to each of the first light sources 61e and the second light sources 62e according to the signal from the action plan unit 42. The external notification control unit 64 can selectively place the headlight 14e in a turned-off state (unlighted state) where all the light sources 61e, 62e of the first light source group 61 and the second light source group 62 are turned off, and a turned-on state (lighted state) which may include a first state (where all of the light sources 61e of the first light source group 61 are turned on and all of the light sources 62e of the second light source group 62 are turned off), and a second state (where all of the light sources 61e of the first light source group 61 are turned off and all of the light sources 62e of the second light source group 62 are turned on).

When the headlight 14e is in the first state, the irradiation distance is 40 m, and the headlight 14e may be referred to as being in low beam (for normal nighttime traveling). On the other hand, when the headlight 14e is in the second state, the irradiation distance is 100 m, and the headlight 14e may be referred to as being in high beam (for nighttime traveling on rural roads). When the lighting mode of the headlight 14e is switched between the first state and the second state, the irradiation distance is changed, and the irradiation direction may also be changed.

The taillight 14g includes a pair of light sources provided on either side of the rear end of the vehicle. The external notification control unit 64 can additionally control the turning on and off of each light source of the taillight 14g provided on the rear end of the vehicle by controlling the voltage applied to each of the light sources of the taillight 14g according to the signal from the action plan unit 42. The external notification control unit 64 may turn on and off the taillight 14g in association with the headlight 14e when necessary.

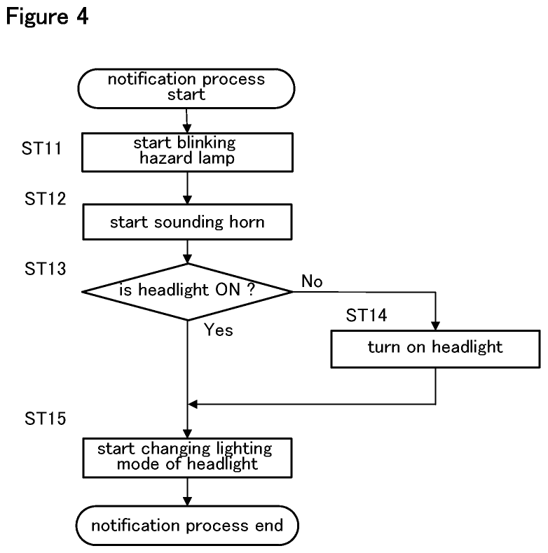

A notification process for operating the external notification device 14 to notify the outside of the vehicle is described in detail in the following with reference to FIG. 4. In the first step ST11 of the notification process, the action plan unit 42 transmits a signal for commanding the external notification control unit 64 to start blinking the hazard lamp 14a and to continue blinking until receiving a signal for commanding the termination thereof. When the transmission of the signal is completed, the action plan unit 42 executes step ST12.

In step ST12, the action plan unit 42 forwards a signal to the external notification control unit 64 to initiate an acoustic notification by using the horn 14c, and to continue the operation of the horn 14c periodically or in a repetitive manner until a command to end the operation of the horn 14c is received. Upon completion of the transmission of the signal, the action plan unit 42 executes step ST13.

In step ST13, the action plan unit 42 determines if the headlight 14e is in a lighted state (either in the first state or the second state). When the headlight 14e is lighted, the taillight 14g is also lighted. When the headlight 14e is not lighted, the action plan unit 42 executes step ST14, and when the headlight 14e is lighted, the action plan unit 42 executes step ST15.

In step ST14, the action plan unit 42 transmits a signal to light up the headlight 14e to the external notification control unit 64. At this time, the action plan unit 42 may command the external notification control unit 64 to set the headlight 14e to the second state. At the same time as lighting up the headlight 14e, the action plan unit 42 commands the external notification control unit 64 to light up the taillight 14g. Upon completion of the transmission of the signal, the action plan unit 42 executes step ST15.

In step ST15, the action plan unit 42 periodically switches the headlight 14e between the first state and the second state, and outputs a signal commanding to repeat the switching until a signal commanding termination is received to the external notification control unit 64. Upon completion of the transmission of the signal, the action plan unit 42 ends the notification process.

Once the notification process is completed, the processes of steps ST2 to ST8 in FIG. 2 are executed. In the stop maintaining process (ST8), the switching is continuously repeated until a signal commanding the end of the switching of the lighting mode of the headlight 14e is transmitted from the action plan unit 42, and received by the external notification control unit 64. The signal for commanding the end of the notification may be transmitted when the vehicle has come to a stop, and a door sensor provided on the door detects the opening of the door. In an alternate embodiment, the transmission is started upon elapsing of a certain time period after the vehicle has come to a stop.

The mode of operation and advantages of the vehicle control system 1 configured as described above are discussed in the following.

In the vehicle control system 1 according to the present embodiment, the first light sources 161e included in the first light source group 161 and the second light sources 162e included in the second light source group 162 are turned on and off alternately so that the state of the headlight 14e is cyclically alternated between the first state and the second state.

When driving the vehicle at night, in particular on a rural road, the driver sets the headlight 14e to the second state in which the irradiation distance is longer, and thus uses the headlight 14e in high beam. When driving the vehicle on urban roads or there is an oncoming vehicle, the driver lowers the irradiation direction of the headlight 14e from the second state to the first state in which the irradiation distance is short, and thus uses the headlight 14e in low beam.

In the present embodiment, the switching of the headlight 14e is performed in a different way from the normal way mentioned above. In the present embodiment, the lighting mode of the headlight 14e is selected for the purpose of providing a notification to the outside of an occurrence of an urgent situation such as when the stop process is being executed, and the control unit 15 or a driver has become incapable of properly maintaining a traveling state of the vehicle.

In the present embodiment, the taillight 14g of the vehicle is turned on in the stop process. This makes it easier for the driver of the following vehicle to recognize that the driver in the autonomous driving vehicle may have become incapable of taking over the driving when required such as when a handover request is made.

In the present embodiment, the abnormal situation can be recognized by the surrounding vehicles and pedestrians by switching between the two lighting modes. Therefore, the configuration of the control unit 15 is simplified as compared with the case where switching is performed between three or more lighting modes.

### <Second Embodiment>

The vehicle control system 101 according to a second embodiment of the present invention which is also shown in FIG. 1 is different from the vehicle control system 1 of the first embodiment in the first state and the second state of the headlight 14e controlled by the external notification control unit 64. The second embodiment is otherwise similar to the first embodiment. The lighting modes in the first state and the second state are discussed in the following in detail, and the remaining part of the vehicle control system 101 is omitted from the following disclosure. In the following disclosure, the parts common to the first embodiment are denoted with the same reference numerals.

The external notification control unit 64 is configured to set the headlight 14e to a first state in which all of the first light sources 161e of the first light source group 161 are turned on, and all of the second light sources 162e of the second light source group 162 are turned off, and a second state in which all of the first light sources 161e of the first light source group 161 are turned on, and all of the second light sources 162e of the second light source group 162 are turned on. When the headlight 14e is in the first state, the irradiation distance is 40 m, and the headlight 14e is in low beam. On the other hand, when the headlight 14e is in the second state, the irradiation distance is 100 m, and the headlight 14e is in high beam. Throughout the time the headlight 14e is switched between the first state and the second state, all the first light sources 161e are kept turned on. Accordingly, light sources having a higher luminance (for example, an HID lamp) can be used as the first light sources 161e even though such light sources may require a certain time period to be fully bright after being turned on. In the present embodiment, the first light sources 161e each consist of an LED lamp or a halogen lamp, but may also be a HID lamp that requires a certain time period to be fully bright after being turned on.

The mode of operation and advantages of the vehicle control system 101 of the second embodiment are discussed in the following.

In the vehicle control system 101 of the second embodiment, when the headlight 14e is periodically switched between the first state and the second state in the lighted state of the headlight 14e, all of the second light sources 162e included in the second light source group 162 are turned on and off while all of the first light sources 161e included in the first light source group 161 are kept turned on.

Therefore, the first light sources 161e of the headlight 14e continue to be turned on while the switching of the lighting mode is being executed. The first light sources 161e may each consist of a light source such as an HID lamp that requires a certain time period to be fully bright after being turned on.

### <Third Embodiment>

The vehicle control system 201 according to a third embodiment of the present invention switches the direction of the light source of the headlight 14e by switching between the first state and the second state as opposed to the vehicle control system 1 of the first embodiment. Further, the configuration of the headlight 14e is slightly different. Hereinafter, the structure and the lighting mode of the headlight 14e are discussed in the following. Since the third embodiment is otherwise similar to the first embodiment, the other part common to the first embodiment is omitted in the following disclosure. In the following disclosure, the parts common to the first embodiment are denoted by the same reference numerals.

The headlight 14e is not provided with light sources corresponding to those of the first light source group 61 in the previous embodiment, and consists solely of a second light source group 262 which includes at least a pair of second light sources 262e provided on either side of the front end of the vehicle. The second light sources 262e may be supported at the front end of the vehicle body so as to be tiltable (rotatable) around a laterally extending rotational axis. Thus, the second light sources 262e are moveable between a first state in which the irradiation direction is slightly downward with respect to the horizontal direction, and a second state in which the irradiation direction is slightly more upward than in the first state. The irradiation distances in the first state and the second state may be similarly determined as in the first embodiment. The second light sources 262e may each consist of an LED light, a HID lamp, or a halogen lamp.

The external notification control unit 64 is configured to control the turning on and off of the second light sources 262e and the irradiation direction thereof by controlling the voltage applied to the second light sources 262e according to the signal from the action plan unit 42. The irradiation direction may be changed by a mechanical arrangement or by selecting the light emitting elements included in the corresponding light source. The external notification control unit 64 can switch the headlight 14e at least between the first state and the second state. When the headlight 14e is in the first state, the irradiation distance is 40 m, and the headlight 14e may be considered to be in low beam. On the other hand, when the headlight 14e is in the second state, the irradiation distance is 100 m, and the headlight 14e may be considered as in high beam.

The mode of operation and the advantages of the vehicle control system 201 of the third embodiment are discussed in the following.

In the vehicle control system 201 according to the third embodiment, the headlight 14e is periodically switched between the first state and the second state by changing the irradiation direction while the second light sources 262e are kept turned on.

Since the switching is performed by changing the irradiation direction, the second light sources 262e are not required to be turned off. Therefore, a light source that has high luminance but requires a long time before lighting can be used as the second light sources 262e. Such light sources may be capable of producing a high intensity light with a relatively small power consumption so that the switching of the lighting mode of the headlight 14e is easily recognized by pedestrians and occupants of surrounding vehicles.

### <Fourth Embodiment>

The vehicle control system 301 according to a fourth embodiment of the present invention differs from the vehicle control system 1 of the first embodiment in that the vehicle control system 301 makes use of the occupant monitoring device 11, and executes step ST21 following the execution of step ST12 in the notification process. The fourth embodiment is otherwise similar to the first embodiment. Hereinafter, step ST21 is described in detail, and the remaining part of the vehicle control system 301 is omitted from the following disclosure. In the following disclosure, the parts common to the first embodiment are denoted by the same reference numerals.

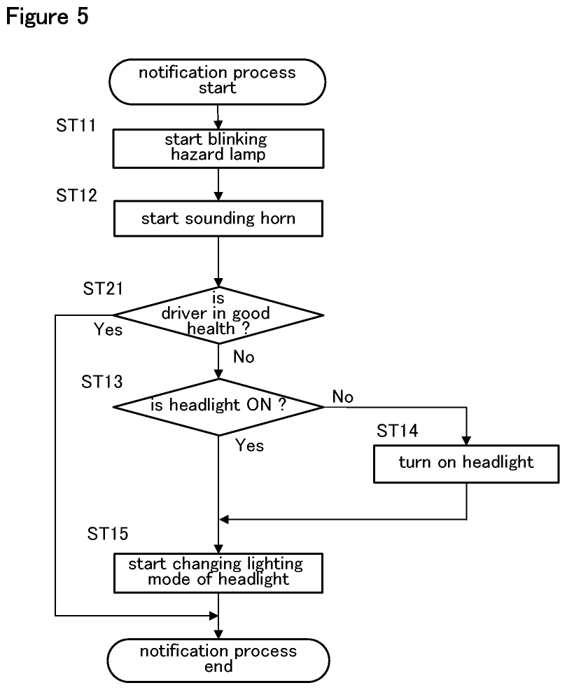

As shown in FIG. 5, in step ST21, the action plan unit 42 acquires the monitoring result of the occupant monitoring device 11, and determines if the driver's health is normal according to the acquired monitoring result. More specifically, the action plan unit 42 determines that the health condition of the driver is normal (in good health) when the heart rate measured by the heart rate sensor is within a predetermined reference range. The reference range is preferably 60 to 90 bpm. When it is determined that the health condition of the driver is not normal (not in good health), the action plan unit 42 executes step ST13, and when it is determined that the health condition of the driver is normal, the subsequent steps ST13 to ST15 are skipped, and the notification process ends. In other words, in this case, switching of the lighting mode of the headlight 14e is prohibited.

In an alternate embodiment, in step ST21, the action plan unit 42 determines the health condition of the driver according to the image captured by the internal camera 26. More specifically, the action plan unit 42 performs a per se known image analysis on the captured image. For example, when it is detected that the driver's eyelids are kept closed for a predetermined period of time or more, the health condition of the driver may be determined to be abnormal.

The mode of operation and the advantages of the vehicle control system 301 of the fourth embodiment are discussed in the following.

In the vehicle control system 301 of the fourth embodiment, even when it is determined that the driver has failed to take over the driving (typically in response to a handover request from the vehicle control system 301), and/or the driver has failed to appropriately monitor the surrounding environment, if the monitoring result of the occupant monitoring device 11 indicates that the driver is in good health, some restriction is made on the changing of the lighting mode of the headlight 14e.

If the driver is in good health, and has failed to properly intervene in (or take over) the driving, it is likely that the driver is still able to cope with the situation. Therefore, by prohibiting the changing of the lighting mode of the headlight 14e, pedestrians and the occupants of surrounding vehicles are prevented from being unnecessarily alarmed by the change in the lighting mode of the headlight 14e.

The present invention has been described in terms of specific embodiments, but is not limited by such embodiment, but can be modified in various ways without departing from the scope of the present invention. For instance, in the third embodiment, the second light sources 262e are each supported by the front end of the vehicle body so as to be rotatable about the rotational axis extending in the lateral direction. However, the present invention is not limited to this mode. For example, the second light sources 262e may be each provided with a reflecting plate which is controlled by the external notification control unit 64 so as to be capable of displacing the irradiation direction in at least two directions (including a first direction which is directed slightly downward with respect to the horizontal direction, and a second direction which is directed slightly more upward than the first direction).

Also, in the foregoing embodiments, the taillight 14g was configured to be turned on and off in conjunction with the turning on and off of the headlight 14e, but the present invention is not limited to this mode. For example, the taillight 14g may be configured to be turned on and off by the action plan unit 42 without being associated with other light sources.

Also, in the foregoing embodiments, the headlight 14e was configured to be periodically switched on and off, but the present invention is not limited to this mode. By turning on/off the headlight 14e, for example, information may be notified to the outside similarly as with the Morse code. With this configuration, for example, when the communication device 8 breaks down, it is possible to notify the outside of the vehicle of the content of the abnormality.

Further, in the foregoing embodiments, the headlight 14e was turned on, and the lighting mode was switched in an alternating manner upon initiation of the stop process. However, the present invention is not limited to this mode. For example, the action plan unit 42 may turn on the headlight 14e and start switching the lighting mode only after the vehicle has come to a stop at the stop position, or, in other words, after the stop maintaining process is initiated.

In the foregoing embodiments, the headlight 14e was switched as a light for changing the lighting mode. Alternatively or additionally, interior lights or other lighting of the vehicle may be turned on and off similarly as the headlight 14e in the foregoing embodiments for accomplishing a similar goal.

1. A vehicle control system configured for autonomous driving, comprising:
a control unit for steering, accelerating, and decelerating a vehicle; and
an external notification device using light;
wherein the control unit is configured to execute a stop process by which the vehicle is parked in a prescribed stop area when it is detected that the control unit or a driver has become incapable of properly maintaining a traveling state of the vehicle, and
wherein the external notification device includes a headlight, and the control unit is configured to change a lighting mode of the headlight in a repetitive manner in the stop process.

2. The vehicle control system according to claim 1, wherein the headlight is configured to be selectable to be in a first state and a second state demonstrating two different irradiation ranges, and the control unit is configured to cause the first state and the second state to alternate in a repetitive manner.

3. The vehicle control system according to claim 2, wherein the headlight includes a first light source and a second light source having to different irradiation ranges, the first light source being turned on while the second light source is turned off in the first state, the first light source being turned off while the second light source is turned on in the second state.

4. The vehicle control system according to claim 2, wherein the headlight includes a first light source and a second light source having different irradiation ranges, the first light source being turned on while the second light source is turned off in the first state, the first light source and the second light source being both turned on in the second state.

5. The vehicle control system according to claim 2, wherein the headlight includes a light source which is selectable to have a first irradiation direction directed lower than a horizontal direction, and a second irradiation direction higher than the first irradiation direction, the first state and the second state corresponding to the first irradiation direction and the second irradiation direction, respectively.

6. The vehicle control system according to claim 1, further comprising an occupant monitoring device, wherein the control unit is configured to prohibit the lighting mode of the headlight from being changed in the repetitive manner in the stop process when the occupant monitoring device indicates that the driver is in a good health.

7. The vehicle control system according to claim 1, wherein the external notification device further includes a taillight, wherein the control unit turns on the taillight as well as the headlight in the stop process.
